(19) United States
(12) Patent Application Publication
(10) Pub. No.: US 2002/0162307 A1
(43) Pub. Date: Nov. 7, 2002

(54) Numnah

(76) Inventor: Anthony Richard Arnold, Welling (GB)

Correspondence Address: ST. ONGE STEWARD JOHNSTON & REENS, LLC, 986 BEDFORD STREET, STAMFORD, CT, 06905-5619, US

(21) Appl. No.: 10/067,720

(22) Filed: Feb. 5, 2002

Related U.S. Application Data
(63) Continuation of application No. PCT/GB00/02688, filed on Jul. 13, 2000.

(30) Foreign Application Priority Data
Aug. 6, 1999 (GB) 9918640.5

(51) Int. Cl. B68B 1/12; B68B 3/08; B68B 3/10; B68B 3/16

(52) U.S. Cl. 54/66

(57) ABSTRACT

The present invention concerns the field of saddlery for the riding of horses and other animals, and particularly relates to numnahs (or saddle cloths) which are interposed between a saddle and the horse, or other animal to be ridden. It is an object of the present invention to provide an improved numnah which has good non-slip performance, but which is more comfortable for the animal being ridden and maintains good resilience during use. According to one aspect of the present invention there is provided a numnah suitable for interposing between a saddle and an animal to be ridden, comprising a foam polymer base layer and a scrim layer attached to one surface of the base layer, wherein the scrim layer comprises a planar polymer foam matrix configured to provide a plurality of open air pockets each extending through the thickness of the scrim to the base layer, the scrim layer providing a non-slip surface which may be juxtaposed the back of the animal.

This application is a continuation of pending International Application PCT/GB00/02688 filed on Jul. 13, 2000, which designates the United States and claims priority from British Application 9918640.5 filed Aug. 6, 1999.

### FIELD OF THE INVENTION

The present invention concerns the field of saddlery for the riding of horses and other animals, and particularly relates to numnahs (or saddle cloths) which are interposed between a saddle and the horse, or other animal to be ridden.

### BACKGROUND OF THE INVENTION

A numnah is traditionally made up of one or more felt, sheepskin or cotton material blankets. The environment in which the numnah has to operate is fairly severe, the numnah being subject to the loading of the rider, heat and sweat from the horse, and shearing loading tending to cause the numnah and saddle to slip to one side or the other off the horse's back. Modern numnahs may be made from man-made materials. Artificial sheepskin numnahs are known to provide a cheap and easily cleanable alternative to the real thing.

Preventing slippage of the numnah is vital for preventing serious injury to the rider which may occur if the saddle slips and the rider or horse falls. International patent publication WO93/15998 discloses a numnah formed from a layer of open cell foam polyvinyl chloride material. This layer is provided with a hot plate-smoothed non-slip surface which is claimed to produce an enhanced frictional contact between the numnah and the horse. U.S. Pat. No. 5,575,139 discloses a non-slip saddle pad made up of multiple layers of material. The lower layer is made from an open-celled foam which has been surface-stripped in order to provide good adhesion with the back of the horse.

One problem with the known synthetic non-slip numnahs as described above is that by maximizing the frictional contact (by for example plate smoothing, or stripping) the numnah can be uncomfortable for the horse because of the intimate contact produced. In addition the synthetic foam tends to absorb sweat, thereby changing its resilience and reducing the padding protection to the horse, whilst also increasing the chance of slipping of the numnah.

### SUMMARY OF THE INVENTION

It is an object of the present invention to provide an improved numnah which has good non-slip performance, but which is more comfortable for the animal being ridden and maintains good resilience during use.

According to one aspect of the present invention there is provided a numnah suitable for interposing between a saddle and an animal to be ridden, comprising a foam polymer base layer and a scrim layer attached to one surface of the base layer, wherein the scrim layer comprises a planar polymer foam matrix configured to provide a plurality of open air pockets each extending through the thickness of the scrim to the base layer, the scrim layer providing a non-slip surface which may be juxtaposed the back of the animal.

The foam constitution of the base layer and the scrim layer provides a resilient padding effect. The air pockets provide aeration of the contact surface, thereby reducing the build-up of sweat, dispersing heat and improving grip.

In a preferred aspect of the invention the foam matrix comprises a network of interconnected foam beads. The foam beads provide discrete contact points as well as providing substantial resilient padding.

The scrim may comprise knitted or woven polyester foam. Preferably the scrim is coated in a non-slip coating, for example a plasticized vinyl compound.

The base layer in one embodiment comprises closed cell foam. This prevents fluid such as animal sweat from being drawn up into the base layer and affecting the padding performance.

In another embodiment, the base layer comprises polyvinyl chloride (PVC) foam, preferably open cell foam. This has good mechanical properties and provides a strong base for the scrim layer.

The scrim layer may be attached to the base layer by conventional techniques. A preferred technique is cold curing.

The density of the base layer closed cell foam may be between 10 kg/m³ and 80 kg/m³. Preferably the base layer, in a PVC embodiment has a density of between 120 kg/m³ and 128 kg/m³.

The base layer may have a thickness of between 4 mm and 25 mm, but preferably the base layer thickness is between 5 mm and 15 mm.

The scrim layer may have a thickness of between 0.5 mm and 8 mm, but thickness of up to 10 mm may be employed. Preferably the thickness is above 3 mm in order to provide the appropriate aeration performance.

The beads of the scrim layer may have a linear dimension of between, 3 mm and 6 mm, although dimensions of up to 12 mm may be employed. The linear dimension may be thickness, diameter or width.

The air pockets may each define a space between beads having a linear dimension of between 3 mm and 6 mm, although up to 12 mm spacing may be provided. The linear dimension may be a separation distance between adjacent bead surfaces.

In a preferred embodiment the scrim comprises a mono-layer of beads. Preferably the mono-layer has a face-centered cubic bead configuration. This provides a substantial air pocket volume.

In yet another aspect of the invention there is provided a saddle for a horse or other ridden animal, which saddle is provided on an underside surface thereof with a numnah as described in the foregoing.

### BRIEF DESCRIPTION OF THE DRAWINGS

Following is a description by way of example only ad with reference to the figures of the drawings of one method of putting the present invention into effect.

In the drawings:

FIG. 1 is a sectional view through a mat according to the present invention.

FIG. 2 is plan view from below of a mat according to the present invention showing the scrim configuration.

FIG. 3 is a plan view from above of a numnah according to the present invention.

FIG. 4 is an end-on view of a saddle according to the present invention.

### DETAILED DESCRIPTION OF THE DRAWINGS

First Embodiment

In FIG. 1 a portion of a mat according to the present invention is shown as 10. The mat has a base layer 11 formed from closed cell foam. A suitable foam is marketed under the trade name GALFOAM Metallocene Foam GM300. This material is available from Palziv of Israel. The material is a cross-linked polyolefin foam formulated using ethylene vinyl acetate and metallocene polyethylene. This particular foam material has a density of about 33 kg/m³, a tensile strength of about 35 N/mm² and a compressive strength of about 16 kPa at 10% deflection, 37.5 kPa at a deflection of 25% and 100 kPa at a deflection of 50% (manufacturer's figures).

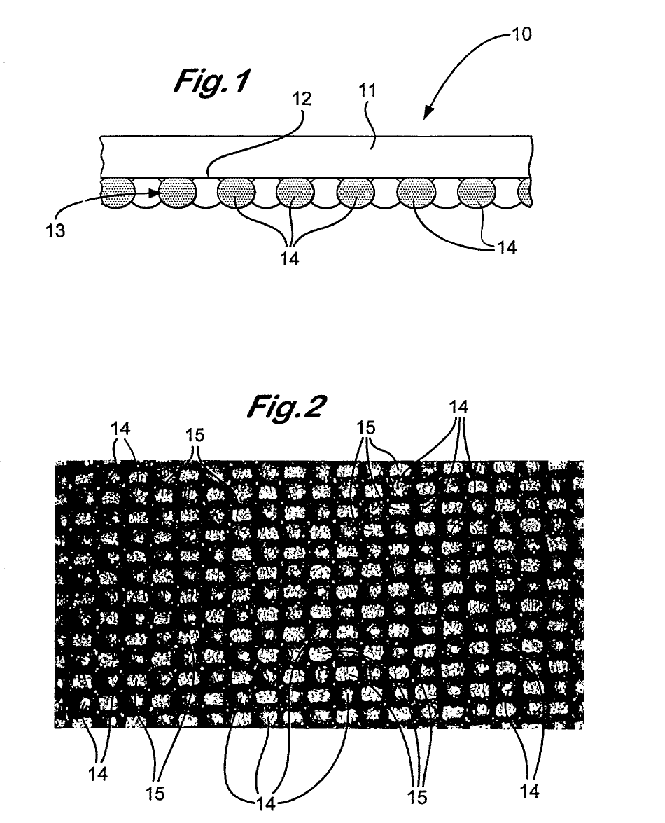

A bottom surface 12 of the base layer is attached to a scrim layer 13. The scrim layer is a knitted or woven polyester coated with a PVC-based non-slip coating, available from Vantage Industries Inc of Atlanta, Ga. USA under the trade name “Sultan”. The scrim layer comprises a mono-layer network of foam beads 14. The beads are interconnected at corner regions thereof as shown in FIG. 2. Between the beads are generally square section air pockets 15. These extend through the thickness of the scrim down to the underlying base layer 11.

The scrim layer is attached to the base layer by conventional cold-cured adhesive. The adhesive is spread over a surface of base layer and the scrim layer is laid on top of the adhesive coating. The thickness of the base layer of this specific embodiment is about 7 mm. The thickness of the scrim layer beads is about 4 mm, giving a total mat thickness of about 11 mm. Taking a plain view of the beads, each bead has a width of about 4 mm and a length of about 6 mm. The beads have a generally rounded configuration, providing a plurality of bumps constituting the exposed scrim surface.

Second Embodiment

In a second embodiment, the base layer 11 is formed from open cell PVC foam. The foam has a density of about 120-128 Kg/m³. PVC provides an inexpensive and strong base layer, which is conducive to a strong bond with the scrim layer. The base layer has a thickness in this embodiment of about 6 mm. The scrim layer is as described in the foregoing, giving a total mat thickness of about 10 mm

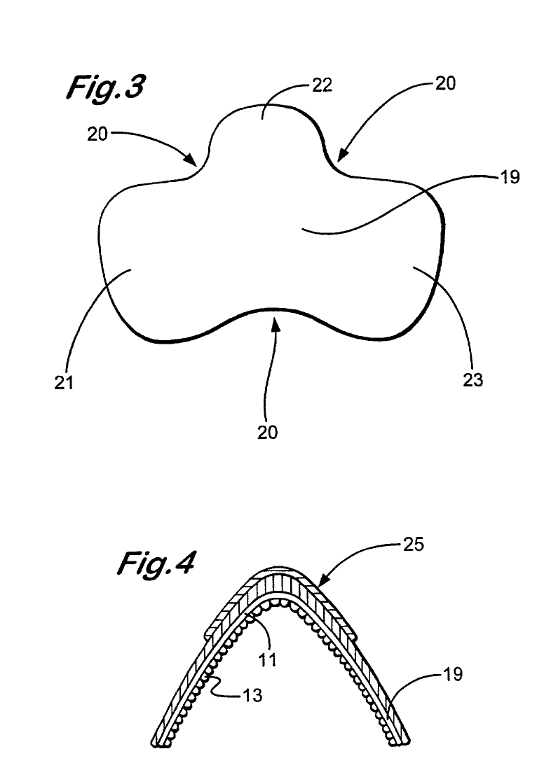

FIG. 3 is a plan view of a numnah 19 made from a mat as hereinbefore described. The mat is shown viewed from a top side thereof (the scrim layer therefore obscured). The mat has a conventional Numnah form, having concave sides 20 and rounded corners 21, 22 and 23. One of the corners 22 is a head portion of the numnah and sits centrally on the back of the horse on which a saddle is to be fitted. The two other corners form flaps which lie on either side of the horse's back, against the flanks of the horse.

FIG. 4 is an end on view of a saddle 25 according to the present invention. The saddle is a conventional leather article shaped to fit on a horses back (not shown). The numnah 19 is placed next to an underside of the saddle, with the base layer facing the saddle, and the scrim layer facing the horse.

In use, the scrim layer provides a non-slip contact for maintaining the saddle in position. The backing layer provides a strong tear resistant backing which gives the scrim strength and integrity which might otherwise be lacking. The air pockets between beads provide aeration and sweat conduits which helps keep the saddle comfortable for the horse.

What is claimed is:

1. A numnah for interposition between a saddle and an animal to be ridden, comprising a foam polymer base layer and a scrim layer attached to one surface of the base layer, wherein the scrim layer comprises a planar polymer foam matrix configured to provide a plurality of open air pockets each extending through the thickness of the scrim to the base layer, the scrim layer providing a non-slip surface which may be juxtaposed the back of the animal.

2. A numnah as claimed in claim 1 wherein the foam matrix comprises a network of interconnected foam beads.

3. A numnah as claimed in any preceding claim wherein the scrim comprises polyester foam.

4. A numnah as claimed in any preceding claim wherein the scrim is coated in a plasticized vinyl compound.

5. A numnah as claimed in any preceding claim wherein the base layer comprises closed cell foam.

6. A numnah as claimed in any of claims 1 to 4 wherein the base layer comprises open cell foam.

7. A numnah as claimed in claim 6 wherein the base layer comprises PVC foam.

8. A numnah as claimed in any preceding claim wherein the scrim layer is attached to the base layer by cold curing.

9. A numnah as claimed in claim 5 wherein the density of the base layer foam is between 10 kg/m³ and 80 kg/m³.

10. A numnah as claimed in claim 6 or claim 7 wherein the density of the base layer is between 120 and 128 kg/m³.

11. A numnah as claimed in any preceding claim wherein the base layer has a thickness of between 4 mm and 25 mm.

12. A numnah as claimed in any preceding claim wherein the base layer has a thickness of between 5 mm and 15 mm.

13. A numnah as claimed in any preceding claim wherein the scrim layer has a thickness of between 0.5 mm and 8 mm.

14. A numnah as claimed in any preceding claim wherein the scrim layer has a thickness of between 3 and 10 mm.

15. A numnah as claimed in claim 2 and any of claims 3 to 14 wherein the beads of the scrim layer have a linear dimension of between 3 mm and 6 mm.

16. A numnah as claimed in claim 2 and any of claims 3 to 14 wherein the beads of the scrim layer have a linear dimension of between 3 mm and 12 mm.

17. A numnah as claimed in any preceding claim wherein the air pockets each have a linear dimension of between 3 mm and 6 mm.

18. A numnah as claimed in any preceding claim wherein the air pockets each have a linear dimension of between 3 mm and 12 mm.

19. A numnah as claimed in any preceding claim wherein the scrim comprises a mono-layer of beads.

20. A numnah as claimed in claim 12 wherein the mono-layer has a faced-centered cubic bead configuration.

21. A saddle for a horse or other ridden animal, which saddle is provided on an underside surface thereof with a numnah as claimed in any preceding claim.

22. A numnah substantially as hereinbefore described with reference to the figures of the drawings.
